(19) United States
(12) Patent Application Publication
(10) Pub. No.: US 2014/0321134 A1
(43) Pub. Date: Oct. 30, 2014

(54) CENTER LAMP BRACKET

(71) Applicants: Jeffrie Scott Bauer, Oxford, IN (US); Brian Clayton Belcher, Brownsburg, IN (US)

(72) Inventors: Jeffrie Scott Bauer, Oxford, IN (US); Brian Clayton Belcher, Brownsburg, IN (US)

(21) Appl. No.: 14/259,692

(22) Filed: Apr. 23, 2014

Related U.S. Application Data
(60) Provisional application No. 61/817,071, filed on Apr. 29, 2013.

(51) Int. Cl. B60Q 1/32; B60Q 1/00

(52) U.S. Cl. CPC B60Q 1/32; B60Q 1/0005
USPC 362/485; 362/549

(57) ABSTRACT

A lamp assembly is mounted to a vehicle, such as a trailer, and is generally centrally located along the length of a sidewall of the vehicle. The lamp assembly includes a lamp bracket and a lamp coupled to the bracket. The lamp bracket includes a mounting plate coupled to the trailer and a cover coupled to the mounting plate for pivoting movement relative to the mounting plate between an opened position and a closed position. In the opened position, the cover is spaced apart from a rear surface of the mounting plate, and in the closed position the cover is coupled to the rear surface of the mounting plate in order to protect a portion of the lamp.

This application claims priority under 35 U.S.C. §119(e) to U.S. Provisional Patent Application Ser. No. 61/817,071 entitled CENTER LAMP BRACKET and filed Apr. 29, 2013, the entirety of which is hereby incorporated by reference herein.

### FIELD OF THE INVENTION

The present invention relates generally to semi-trailers, such as van-type trailers, for example. In particular, the present invention relates to a center lamp bracket for a center lamp harness of the trailer body.

### BACKGROUND OF THE INVENTION

### Summary

The present invention may comprise one or more of the features recited in the attached claims, and/or one or more of the following features and combinations thereof.

According to one aspect of the present disclosure, a lamp bracket that is configured to be mounted to a vehicle includes a mounting plate configured to be coupled to the vehicle and configured to be coupled to a lamp. The lamp bracket further includes a cover coupled to the mounting plate for pivoting movement relative to the mounting plate between an opened position and a closed position. In the opened position, the cover is spaced apart from a rear surface of the mounting plate. In the closed position, the cover is coupled to the rear surface of the mounting plate. Illustratively, the cover is configured to protect a portion of the lamp when the cover is in the closed position.

In one illustrative embodiment, the lamp bracket may also include a hinge coupled to the mounting plate and the cover. Illustratively, the mounting bracket and cover may be injection molded to form a one-piece structure. The hinge may define an axis about which the cover rotates as the cover is moved between the opened and closed positions. Illustratively, the hinge may be a living hinge. Further illustratively, the mounting bracket, cover, and living hinge may be injection molded to form a one-piece structure.

In another illustrative embodiment, the lamp bracket may also include a pair of clips coupled to the rear surface of the mounting plate. The pair of clips may be configured to receive a cable of the lamp therebetween.

In yet another illustrative embodiment, the lamp bracket may also include a locking mechanism configured to maintain the cover in the closed position. Illustratively, the locking mechanism may include a first securement tab coupled to the cover and a second securement tab coupled to the mounting plate. Further illustratively, the first and second securement tabs may be engaged with and coupled to each other when the cover is in the closed position. The first securement tab may illustratively be located adjacent a bottom edge of the cover and the second securement tab may illustratively be coupled to a rear surface of the mounting plate at a location generally above an aperture of the mounting plate configured to receive the lamp therein.

In still another illustrative embodiment, the cover may include a main body and end walls coupled to the main body. Illustratively, at least one of the end walls may include a slot configured to receive a cable of the lamp therethrough. Further illustratively, the body of the cover may be curved. The cover may also include a second slot formed in an upper edge of the body of the cover. The second slot may be generally centrally located along a width of the body.

According to yet another aspect of the present disclosure, a lamp bracket configured to be mounted to a vehicle includes a mounting plate configured to be coupled to the vehicle and configured to be coupled to a lamp, The mounting plate includes an outside surface, an inside surface, and an aperture configured to receive the lamp therein. The lamp bracket further includes a cover coupled to the inside surface of the mounting plate and configured to be positioned over the aperture in order to cover a rear portion of the lamp.

In one illustrative embodiment, the lamp bracket may also include a tab coupled to and extending upwardly from an upper edge of the mounting plate. Illustratively, the tab may be configured to be coupled to a base rail of the trailer. The mounting plate may be configured to be located below the base rail.

In another illustrative embodiment, the lamp bracket may also include a pair of cable clips coupled to the inside surface of the mounting plate at a location generally to one side of the aperture. The pair of cable clips may be configured to receive a harness of the lamp therebetween in order to secure the harness to the inside surface of the mounting plate.

In still another illustrative embodiment, the cover may be configured to move between a closed position wherein the cover is positioned over the aperture of the mounting plate and an opened position wherein the cover is spaced-apart from the aperture of the mounting plate. Illustratively, a bottom edge of the cover may be removably coupled to the inside of the mounting plate. Further, an upper edge of the cover may be pivtoably coupled to the mounting bracket.

In yet another illustrative embodiment, the cover may include a main body and end walls coupled to and cooperating with the main body to define a lamp-receiving space therein.

According to still another aspect of the present disclosure, a lamp bracket configured to be mounted to a vehicle includes a mounting plate configured to be coupled to the vehicle and a cover having a first end pivotably coupled to the mounting plate and a second end removably coupled to the mounting plate. Illustratively, the mounting plate includes an aperture configured to receive a lamp therethrough. Further illustratively, the cover is movable between an opened position wherein the second end is coupled to the mounting plate and the cover is located over the aperture and a closed position wherein the second end is spaced-apart from the mounting plate.

In one illustrative embodiment, the lamp bracket may also include a first securement tab coupled to the cover and a second securement tab coupled to the mounting plate and selectively able to be coupled to the first securement tab to maintain the cover in the closed position.

In another illustrative embodiment the lamp bracket may also include a cable clip coupled to the mounting plate and configured to receive a harness of the lamp.

### BRIEF DESCRIPTION OF THE DRAWINGS

FIG. 1 is a perspective view of a trailer showing a center lamp assembly coupled to one of the sidewalls of the trailer.

FIG. 2 is a front, perspective view of the center lamp assembly of FIG. 1 showing a center lamp and a center lamp bracket of the assembly in a closed position.

FIG. 3 is a rear, perspective view of the center lamp assembly of FIGS. 1 and 2 in the closed position.

FIG. 4 is a rear, perspective view of the center lamp bracket of FIGS. 1-3 showing the bracket in an opened position.

FIG. 5 is a front, perspective view of the center lamp bracket of FIGS. 1-4 in the opened position.

### DETAILED DESCRIPTION OF THE PREFERRED EMBODIMENT

For the purposes of promoting an understanding of the principles of the invention, reference will now be made to illustrative embodiments shown in the attached drawings and specific language will be used to describe the same. While the concepts of this disclosure are described in relation to a truck trailer, it will be understood that they are equally applicable to other vehicles generally, and more specifically to conventional flat-bed and/or box or van type trailers, examples of which include, but should not be limited to, straight truck bodies, small personal and/or commercial trailers and the like. Accordingly, those skilled in the art will appreciate that the present invention may be implemented in a number of different applications and embodiments and is not specifically limited in its application to the particular embodiments depicted herein.

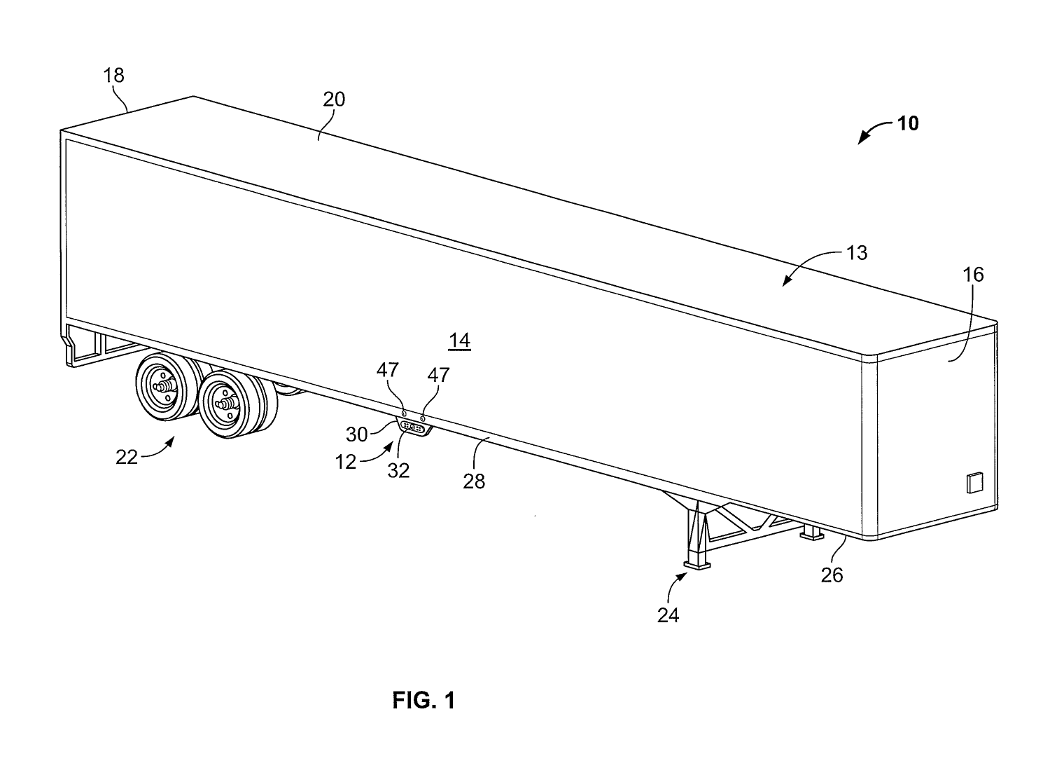

Looking first to FIG. 1, a trailer 10 is provided including a center lamp assembly 12 coupled to and extending downwardly from a sidewall 14 of the trailer 10. Illustratively, the center lamp assembly 12 is positioned approximately mid-way along the length of the sidewall 14 in order to be generally centrally located on the sidewall 14 of the trailer 10. Illustratively, the trailer 10 includes a storage container 13 configured to carry cargo therein. The storage container 13 includes two sidewalls 14, a front end wall assembly 16, a rear end wall assembly 18, a roof assembly 20 and a floor assembly 26 which all cooperate together to define an inside portion of the container 13 to store various articles or goods therein. The trailer 10 further includes a rear wheel assembly 22 and a front support or landing gear 24 each coupled to the floor assembly 26. A center lamp assembly 12 is coupled to each sidewall of the trailer 10.

Illustratively, the sidewalls 14 of the trailer 10 each include a base rail 28 extending along a length of the trailer 10. The base rail 28 is also coupled to the floor assembly 26 of the trailer 10. The front end of the trailer 10 is configured to be coupled to a tractor (not shown) for towing the trailer 10 thereon thus providing a tractor-trailer assembly. It should be understood that while the center lamp assembly 12 of the present invention is shown for use with the illustrative trailer 10, it is within the scope of this disclosure for the center lamp assembly 12 to be used on any suitable trailer, van, truck body, flat bed, car, or other vehicle in order to provide a generally central, side lamp along the sidewall of the vehicle. The trailer 10 includes a center lamp assembly 12 coupled to each sidewall 14. Thus, the trailer 10 includes a right and a left center lamp assembly 12. However, for purposes of this discussion, only the right center lamp assembly 12 shown in FIG. 1 is described herein. It should be understood, however, that the left center lamp assembly 12 is the same in cooperation and configuration as the right center lamp assembly 12. Further, while center lamp assembly 12 disclosed herein is located along the sidewall of the trailer 10, it should be understood that the center lamp assembly 12 may be coupled to any portion of the trailer 10.

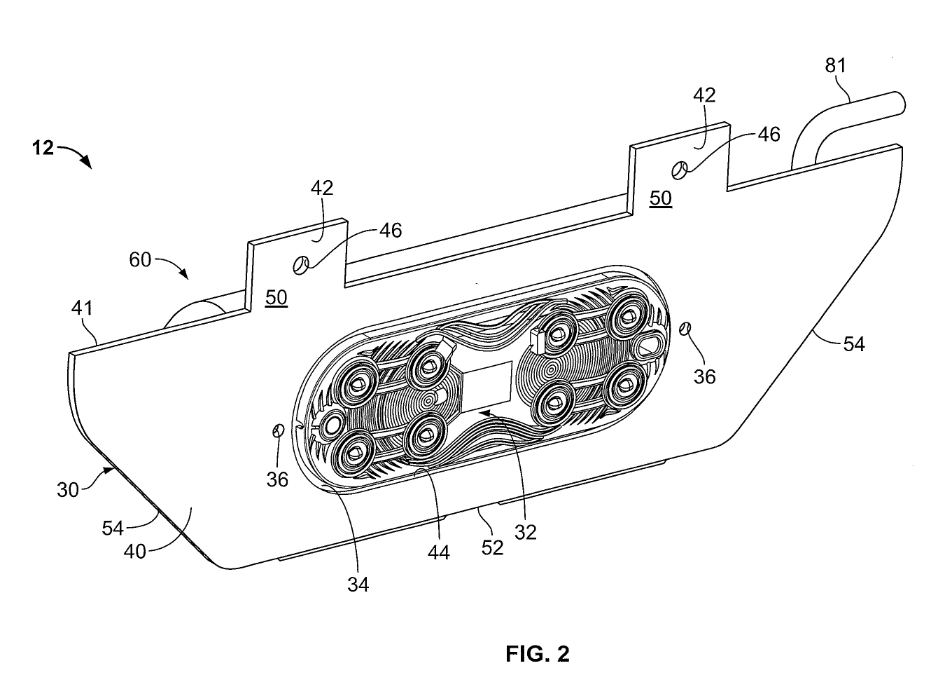

Looking now to FIG. 2, the center lamp assembly 12 includes a center lamp bracket 30 and a center lamp 32 coupled to the center lamp bracket 30, as is described in greater detail below. The illustrative center lamp 32 is oval in shape and is coupled to the center lamp bracket 30 by mechanical fasteners (not shown) such as screws. The screws are received through a mounting portion 34 of the central lamp 32 and apertures 36 of the center lamp bracket 30. However, it should be understood that any suitable center lamp 32 of any suitable shape and size may be provided for cooperative use with the center lamp bracket 30. Further, the center lamp bracket 30 may be modified to cooperate with any suitable center lamp 32 and/or any suitable lamp. In other words, it should be understood that the center lamp bracket 30 may simply be a lamp bracket for use with any suitable lamp, including center lamps such as the center lamp 32, as well as other lamps.

Looking now to FIGS. 2-5, the center lamp bracket 30 includes a mounting plate 40 and two tabs 42 coupled to an upper edge 41 of the mounting plate 40. The tabs 42 extend upwardly from the upper edge 41 and are provided to mount the center lamp bracket 30 to the base rail 28 of the trailer 10. In particular, each tab 42 includes an aperture 46 configured to receive a mechanical fastener, such as a screw or rivet therethrough, in order to mount the center lamp bracket 30 to the base rail 28. Illustratively, an outside surface 50 of the tabs 42 is configured to engage an inside surface (not shown) of the base rail 28 when the center lamp bracket 30 is coupled thereto. Thus, a mechanical fastener is received through the aperture 46 of each of the tabs 42 and through the base rail 28 in order to couple the center lamp bracket 30 to the base rail 28 such that the center lamp 32 of the assembly 12 is located below the base rail 28 of the trailer 10 to be visible by other vehicles on the road. One or more additional brackets (not shown) may also be used to couple the center lamp bracket 30 to the base rail 28 of the trailer 10. While the center lamp bracket 30 is described herein as being configured for attachment to the inside surface of the base rail 28 of the trailer 10, it should be understood that the center lamp bracket 30 may be configured to attached to any suitable location on the trailer 10.

Illustratively, the mounting plate 40 of the center lamp bracket 30 includes an aperture 44 sized and configured to receive the center lamp 32 therethrough, as shown in FIG. 2. As noted above, the aperture 44 may be sized and configured to receive any suitable center lamp having any shape or size. Thus, the aperture 44 may be larger, smaller, or shaped differently than the particular oval aperture 44 shown in FIGS. 2, 4, and 5. The mounting plate 40 further includes the apertures 36 described above which are each provided to receive a fastener therethrough in order to couple the center lamp 32 to the center lamp bracket 30. As shown in FIG. 2, the mounting plate 40 is generally trapezoidal in shape such that the mounting plate 40 includes the upper edge 41, a shorter, lower edge 52 and angled side edges 54 coupled to and extending between the upper and lower edges 41, 52.

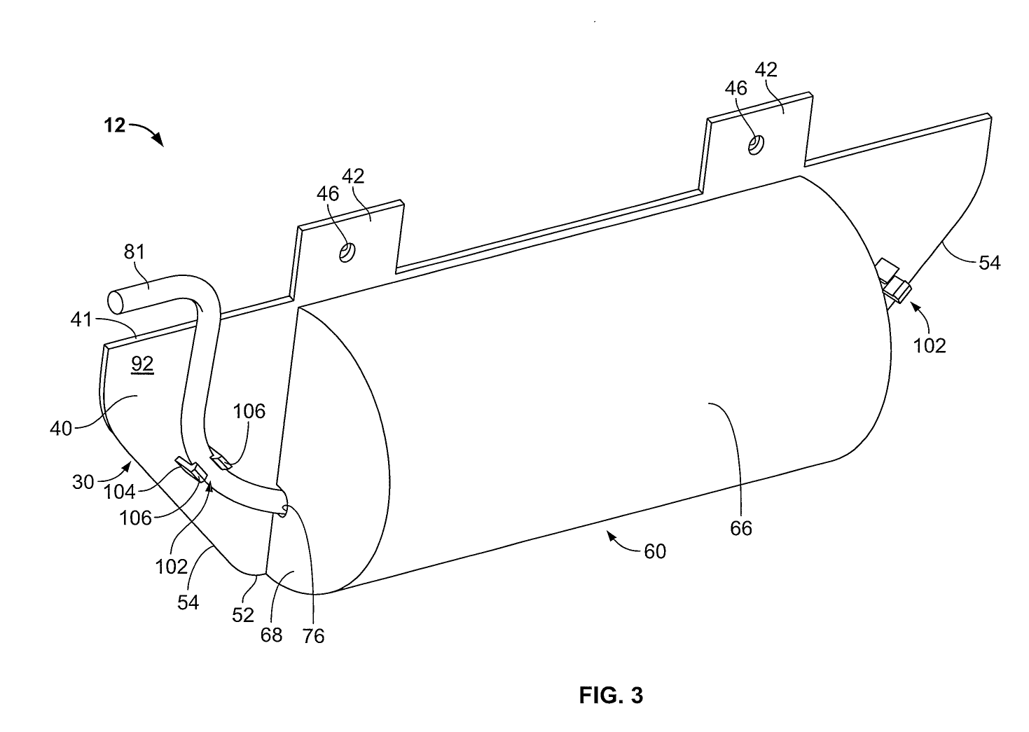

Looking now to FIGS. 3-5, the center lamp bracket 30 further includes a cover 60 coupled to the mounting plate 40 by a living hinge 61 in order to allow the mounting plate 40 and the cover 60 to hingedly pivot about an axis 64 relative to each other. Illustratively, the living hinge 61 includes two spaced-apart living hinge components 62 each coupled to both the mounting plate 40 and the cover 60. It should be understood that the living hinge 61 may include any number of living hinge components 62 including a single living hinge component 62 between the mounting plate 40 and the cover 60. Further, while the illustrative living hinge 61 is shown, it should be understood that the center lamp bracket 30 may include any suitable hinge, such as a butterfly hinge or a butt hinge, for example, in order to pivotably couple the mounting plate 40 and the cover 60 to each other.

Illustratively, the center lamp bracket 30 is a one-piece design such that the cover 60 and the mounting bracket 40 are manufactured as a single piece to provide a unitary, or monolithic, bracket. It should be understood, however, that it is within the scope of this disclosure to provide a center lamp bracket 30 including various components manufactured separately and assembled or coupled together using one or more suitable mechanical fasteners and/or adhesives. Further illustratively, the center lamp bracket is made from an injection molded plastic, such as, but not limited to a thermoplastic. Accordingly, each component, or feature, of the center lamp bracket 30, including the mounting plate 40, the cover 60, the living hinge 61, etc., is made during an injection molding process using aforementioned plastic.

The cover 60 includes a curved body 66 and an end wall 68 coupled to each end of the curved body 66. The curved body 66 and end walls 68 cooperate to define a lamp-receiving space 70 therein. As is described in greater detail below, a rear portion of the center lamp 32 (including a lamp connector (not shown) coupled with a harness 81 (including various cable wires), and a mating harness connector (not shown)) is received within the space 70 when the cover 60 is in the closed position. Thus, the cover 60 operates to protect the rear portion of the center lamp 32 when the cover 60 is in the closed position.

Illustratively, the curved body 66 is curved such that a cross-section of the curved body 66 is generally C-shaped. Thus, each end wall 68 is illustratively generally D-shaped to define a vertical edge 72 and a curved edge 74 in order to cooperate with each end of the curved body 66 to define the partially-enclosed lamp-receiving space 70 therein. While the illustrative cover 60 includes the generally C-shaped curved body 66, it should be understood that the cover 60 may include a body defining any suitable shape, and that the end walls may also define any suitable shape to cooperate with the body, to define a lamp-receiving space therein.

As shown in FIGS. 3-5, each end wall 68 includes a C-shaped slot 76 formed in the vertical edge 72 thereof. As is discussed in greater detail below, the slot 76 is provided to allow a cable, or harness, 81 of the center lamp 32 to pass through either one of the end walls 68.

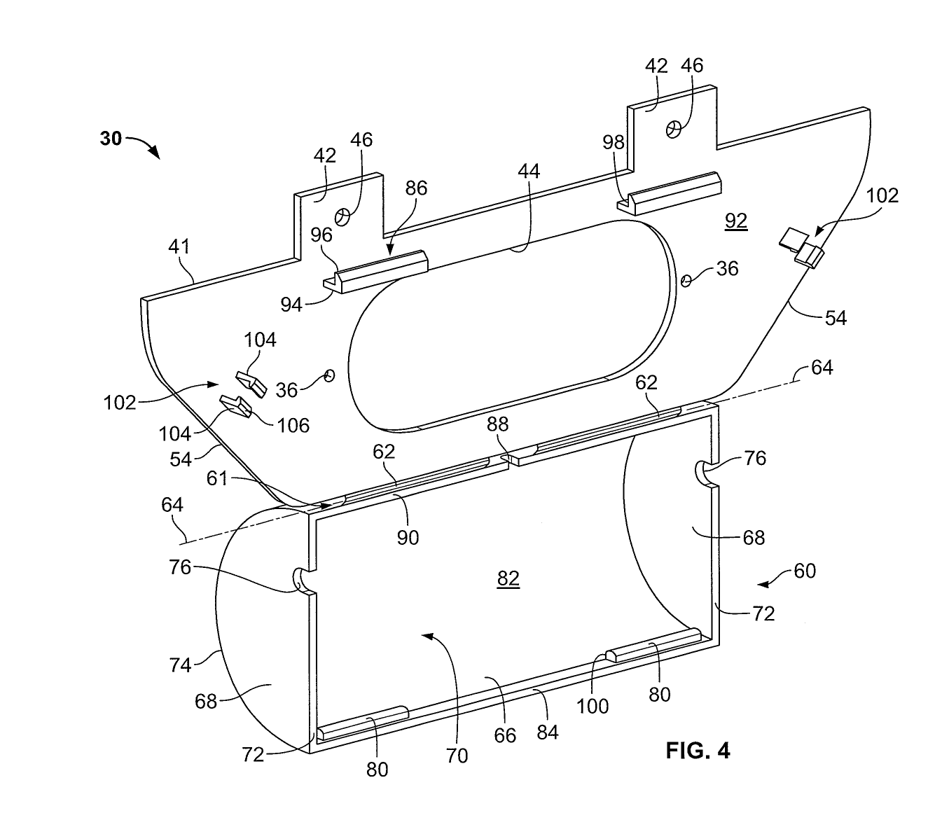

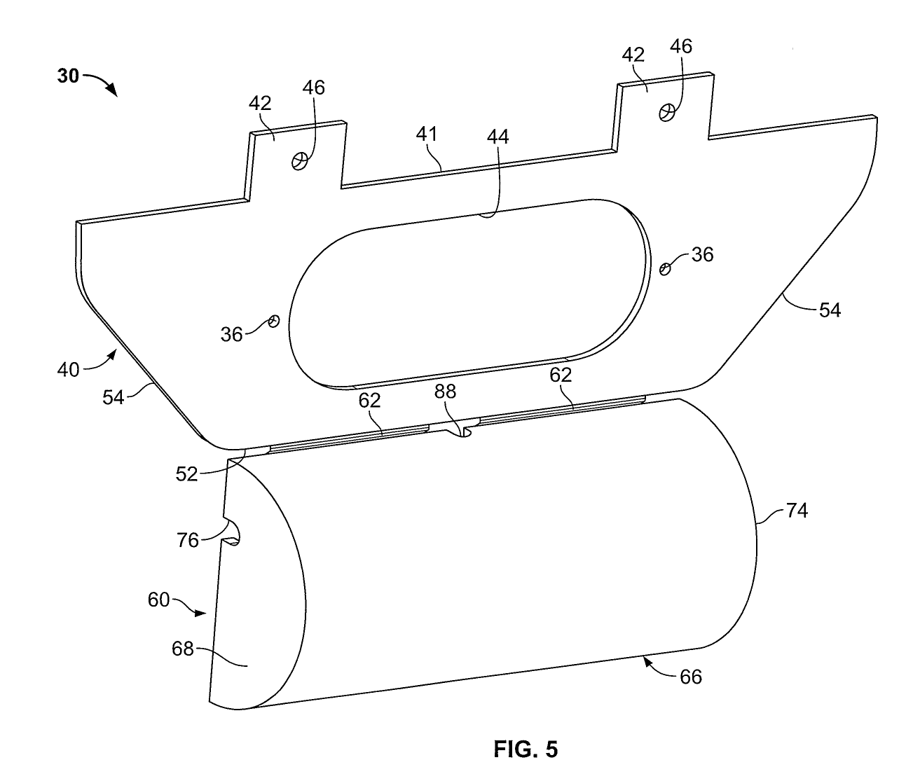

Illustratively, as shown in FIG. 4, the cover 60 further includes a pair of first securement tabs 80. The first securement tabs 80 are spaced-apart from each other and are coupled to an inside surface 82 of the curved body 66 of the cover 60 near a bottom edge 84 of the curved body 66. As is discussed below, the first securement tabs 80 cooperate with a pair of second securement tabs 86 of the mounting plate 40. The cover 60 further includes a top slot or generally C-shaped channel 88, or drainage aperture, formed in an upper edge 90 of the curved body 66. In use, the channel 88 provides an exit pathway for any water which may make its way into the cover 60. As shown in FIG. 2, the channel 88 is located at the bottom of the cover 60 when the cover is in the closed position. As such, any water which may make its way into the cover 60 is able to drain downwardly toward the channel 88 in order to exit the cover 60 therethrough. Looking now to FIG. 5, an inside surface 92 of the mounting plate 40 is shown. Illustratively, the second securement tabs 86 are coupled to the inside surface 92 of the mounting plate 40 at a location above the central lamp aperture 44. As noted above, the second securement tabs 86 are sized and configured to cooperate with the first securement tabs 80 of the cover 60 in order to allow the cover 60 to be moved to an maintained in a closed position (as shown in FIG. 3). Each of the second securement tabs 86 includes a base 94 having one end coupled to the inside surface 92 of the mounting plate 40 and a rib or flange 96 coupled to a distal end of the base 94 and extending upwardly therefrom to define a generally L-shaped cross-section of the second securement tabs 86. Illustratively, the flange 96 defines a mating surface 98 configured to matingly engage with an inner surface 100 of each respective first securement tab 80 when the cover 60 is in the closed position.

Looking still to FIG. 5, a first pair of cable clips 102 is coupled to the inside surface 92 of the mounting plate 40 at a location generally aligned with the center lamp aperture 44. A second pair of cable clips 102 is also coupled to the inside surface 92 of the mounting plate 40 at a location generally aligned with and on the opposite side of the aperture 44 from the first pair of cable clips 102. Illustratively each pair of cable clips 102 is oriented to be aligned with the respective adjacent, angled edge 54 of the mounting plate 40. However, the first and second pairs of cable clips 102 may be positioned at any suitable location on the inside surface 92 of the mounting plate 40. Each cable clip 102 includes a base portion 104 coupled to the inside surface 92 of the mounting plate 40 and a lip or flange 106 coupled to the distal end of the base portion 104. Accordingly, and similar to the second securement tabs 86, the clips 92 each define a generally L-shaped cross section. As is discussed in greater detail below, each pair of cable clips 102 is provided to receive a cable or harness, such as the harness 81, of the center lamp 32 therebetween, as shown in FIG. 3. The clips 102 contain the center lamp harness 81 securely behind the mounting plate 40 of the bracket 30 and position the harness 81 to maintain a secured connection of the harness 81 and a constant drip-loop for the harness 81. Illustratively, the slot 76 into which the harness 81 is received is located below the attachment point of the harness 81 to the lamp 32. Thus, any water which may leak into the cover 60 via the harness 81 and the slot 88 is prevented from traveling up the harness 81 to the lamp 32. Thus, the electrical connection point between the harness 81 and the lamp 32 is protected from water damage. Further, as noted above, any water which may leak into the cover 60 is drained through the slot 52 at the bottom of the cover 60. The clips 102 further eliminate the necessity for cable ties (not shown) typically used to position the cable in a desirable location.

In use, the cover 60 of the center lamp bracket 30 is movable between an opened position (as shown in FIGS. 4 and 5) and a closed position (as shown in FIGS. 2 and 3). In the opened position, the rear portion of the center lamp 32 remains exposed and unprotected while the cover 60 extends, or hangs, downwardly from the bottom edge 52 of the mounting plate 40. In the closed position, the cover 60 encloses center lamp 32 such that the rear portion of the center lamp 32 is received within the lamp-receiving space 70 of the cover. Thus, the cover 60 folds upward about the axis 64 to protect the rear portion of the center lamp 32 from water and debris as the trailer 10 travels down the road. Such protection of the rear portion of the center lamp 32 may reduce maintenance required for the center lamp 32. In order to maintain the cover 60 in the closed position, the first securement tabs 80 are engaged with and coupled to the respective second securement tabs 86 when the cover 60 is pivoted approximately 180 degrees about the axis 64 from the opened position shown in FIGS. 4 and 5 to the closed position shown in FIGS. 2 and 3. As the cover 60 is moved to the closed position, each first securement tab 80 is received within the space between the mating surface 98 of the respective second engagement tab 86 and the inside surface 92 of the mounting bracket 40 such that the inner surface 100 of the first securement tab 80 is engaged with the mating surface 98 of the second securement tab 86. Also, the second securement tab 86 is oriented to face upwardly so that the first securement tab 80 also operates to engage the upwardly-facing surface of the base 94 of the respective second securement tab 86.

Illustratively, the first and second securement tabs 80, 86 of the center lamp bracket 30 cooperate with each other to provide a locking mechanism of the center lamp bracket 30. Further illustratively, the locking mechanism of the center lamp bracket 30 allows a user to move the cover 60 to the closed position to maintain the cover 60 in the closed position, but also allows the user to “unlock” the cover and move the cover 60 from the closed position to the opened position in order to remove and replace the center lamp 32, for example. While the particular locking mechanism including the first and second securement tabs 80, 86 is shown herein, it should be understood that the center lamp bracket 30 may include any suitable locking mechanism configured to maintain the cover 60 in the closed position.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected.

What is claimed is:

1. A lamp bracket configured to be mounted to a vehicle, comprising:
a mounting plate configured to be coupled to the vehicle and configured to be coupled to a lamp; and
a cover coupled to the mounting plate for pivoting movement relative to the mounting plate between an opened position wherein the cover is spaced apart from a rear surface of the mounting plate and a closed position wherein the cover is coupled to the rear surface of the mounting plate, wherein the cover is configured to protect a portion of the lamp when the cover is in the closed position.

2. The lamp bracket of claim 1, further comprising a hinge coupled to the mounting plate and the cover, wherein the hinge defines an axis about which the cover rotates as the cover is moved between the opened and closed positions.

3. The lamp bracket of claim 2, wherein the hinge is a living hinge.

4. The lamp bracket of claim 1, further comprising a pair of clips coupled to the rear surface of the mounting plate, wherein the pair of clips is configured to receive a cable of the lamp therebetween.

5. The lamp bracket of claim 1, further comprising a locking mechanism configured to maintain the cover in the closed position.

6. The lamp bracket of claim 5, wherein the locking mechanism includes a first securement tab coupled to the cover and a second securement tab coupled to the mounting plate, and wherein the first and second securement tabs are engaged with and coupled to each other when the cover is in the closed position.

7. The lamp bracket of claim 6, wherein the first securement tab is coupled adjacent a bottom edge of the cover and wherein the second securement tab is coupled to a rear surface of the mounting plate at a location generally above an aperture of the mounting plate configured to receive the lamp therein.

8. The lamp bracket of claim 1, wherein the cover includes a main body and end walls coupled to the main body, and wherein at least one of the end walls includes a slot configured to receive a cable of the lamp therethrough.

9. The lamp bracket of claim 8, wherein the body of the cover is curved.

10. The lamp of claim 8, wherein the cover further includes a drainage aperture formed in an upper edge of the body of the cover in order to allow water to exit the area between the mounting plate and the cover.

11. The lamp of claim 2, wherein the mounting bracket, cover, and hinge are injection molded to form a one-piece structure.

12. A lamp bracket configured to be mounted to a vehicle, comprising:
a mounting plate configured to be coupled to the vehicle and configured to be coupled to a lamp, wherein the mounting plate includes an outside surface, an inside surface, and an aperture configured to receive the lamp therein; and
a cover coupled to the inside surface of the mounting plate and configured to be positioned over the aperture in order to cover a rear portion of the lamp.

13. The lamp bracket of claim 12, further comprising a tab coupled to and extending upwardly from an upper edge of the mounting plate, wherein the tab is configured to be coupled to a base rail of the trailer and the mounting plate is configured to be located below the base rail.

14. The lamp bracket of claim 12, further comprising a pair of cable clips coupled to the inside surface of the mounting plate at a location generally to one side of the aperture, wherein the pair of cable clips is configured to receive a harness of the lamp therebetween in order to secure the harness to the inside surface of the mounting plate.

15. The lamp bracket of claim 12, wherein the cover is configured to move between a closed position wherein the cover is positioned over the aperture of the mounting plate and an opened position wherein the cover is spaced-apart from the aperture of the mounting plate.

16. The lamp bracket of claim 15, wherein a bottom edge of the cover is removably coupled to the inside of the mounting plate, and wherein an upper edge of the cover is pivtoably coupled to the mounting bracket.

17. The lamp bracket of claim 12, wherein the cover includes a main body and end walls coupled to and cooperating with the main body to define a lamp-receiving space therein.

18. A lamp bracket configured to be mounted to a vehicle, comprising:
a mounting plate configured to be coupled to the vehicle, wherein the mounting plate includes an aperture configured to receive a lamp therethrough; and
a cover having a first end pivotably coupled to the mounting plate and a second end removably coupled to the mounting plate, wherein the cover is movable between an opened position wherein the second end is coupled to the mounting plate and the cover is located over the aperture and a closed position wherein the second end is spaced-apart from the mounting plate.

19. The lamp bracket of claim 18, further comprising a first securement tab coupled to the cover and a second securement tab coupled to the mounting plate and selectively able to be coupled to the first securement tab to maintain the cover in the closed position.

20. The lamp bracket of claim 18, further comprising a cable clip coupled to the mounting plate and configured to receive a harness of the lamp.
